(19) United States
(12) Patent Application Publication
(10) Pub. No.: US 2026/0268489 A1
(43) Pub. Date: Sep. 10, 2026

(54) MULTIMODAL CELL CLASSIFICATION

(71) Applicant: BECKMAN COULTER, INC., Miami, FL (US)

(72) Inventors: Jiuliu Lu, Miami, FL (US); Bart WANDERS, Trabuco Canyon, CA (US)

(21) Appl. No.: 19/558,213

(22) Filed: Mar. 5, 2026

Related U.S. Application Data
(60) Provisional application No. 63/768,067, filed on Mar. 6, 2025.

(51) Int. Cl. G06T 7/00

(52) U.S. Cl. CPC G06T 7/0012; G06T 2207/10004; G06T 2207/20084; G06T 2207/30024; G06T 2207/30168

(57) ABSTRACT

Particles from a biological sample may be classified based on both images of the particles and associated metadata. For example, this may be done using a method which comprises obtaining an image of a particle from a biological sample and obtaining one or more metadata values corresponding to the particle from the biological sample. Such a method may also include classifying the particle from the biological sample based on the image and on the one or more metadata values.

### CROSS REFERENCE TO RELATED APPLICATIONS

This is a non-provisional of, and claims the benefit of U.S. provisional patent application 63/768,067, filed Mar. 6, 2025 for “Multimodal Cell Classification,” the disclosure of which is hereby incorporated by reference in its entirety.

### BACKGROUND

Blood cell analysis is one of the most commonly performed medical tests for providing an overview of a patient's health status. A blood sample can be drawn from a patient's body and stored in a test tube containing an anticoagulant to prevent clotting. A whole blood sample normally comprises three major classes of blood cells including red blood cells (erythrocytes), white blood cells (leukocytes) and platelets (thrombocytes). Each class can be further divided into subclasses of members. For example, five major types or subclasses of white blood cells (WBCs) have different shapes and functions. White blood cells may include neutrophils, lymphocytes, monocytes, eosinophils, and basophils. There are also subclasses of the red blood cell types. The appearances of particles in a sample may differ according to pathological conditions, cell maturity and other causes. Red blood cell subclasses may include reticulocytes and nucleated red blood cells.

The enumeration of different classes and subclasses of cells can be an important tool for detecting pathological conditions such as various forms of infection. For example, the 5-part WBC Differential has for long been an invaluable test in the detection of hematological conditions. The 5-part Differential detects and enumerates the five major subtypes of WBC that are normally found in the peripheral blood, i.e., neutrophils, lymphocytes, monocytes, eosinophils and basophils. Other types of cell class and subclass identification can also be useful. For example, identification of cells in intermediate stages of maturation, such as early granulated cells, blast cells and/or band cells can also be useful in detection of various hematology disorders.

While determining classes and/or subclasses for cells can be useful, there are various obstacles associated with making such a determination. For example, there may be limited time for staining/lysing or otherwise preparing a sample for analysis, or cells in a sample may be oriented sideways or otherwise not be aligned in a manner which is optimal for classification. Additionally, in cases where analysis is based on imaging, the images may be blurry (e.g., due to being out of focus) and so may not clearly depict all cell characteristics which could be useful for classification. As a result, there is a need for improved classification technology which can address obstacles associated with image classification.

### SUMMARY

Described herein are methods and devices for classifying particles from biological samples.

Some aspects of the disclosed technology may be used for classifying particles from a biological sample based on both images of the particles and associated metadata. This may be done, for example, using a method which comprises obtaining an image of a particle from a biological sample and obtaining one or more metadata values corresponding to the particle from the biological sample. Such a method may also include classifying the particle from the biological sample based on the image and on the one or more metadata values. Systems, computer program products, and computer readable media corresponding to such methods may also be implemented based on this disclosure.

Some aspects of the disclosed technology may be used for training classifiers which would classify particles based on both images of the particles and associated metadata. This may be done, for example, using a method which comprises obtaining an image of a particle from a biological sample and obtaining one or more metadata values corresponding to the particle from the biological sample. Such a method may also include using the image of the particle and the one or more metadata values corresponding to the particle to train a classifier to classify particles in biological samples.

While multiple examples are described herein, still other examples of the described subject matter will become apparent to those skilled in the art from the following detailed description and drawings, which show and describe illustrative examples of disclosed subject matter. As will be realized, the disclosed subject matter is capable of modifications in various aspects, all without departing from the spirit and scope of the described subject matter. Accordingly, the drawings and detailed description are to be regarded as illustrative in nature and not restrictive.

### BRIEF DESCRIPTION OF THE DRAWINGS

While the specification concludes with claims which particularly point out and distinctly claim the invention, it is believed the present invention will be better understood from the following description of certain examples taken in conjunction with the accompanying drawings, in which like reference numerals identify the same elements and in which:

FIG. 1 is a schematic illustration, partly in section and not to scale, showing operational aspects of an exemplary flowcell and high optical resolution imaging device for sample image analysis using digital image processing.

FIG. 2 illustrates a method in which metadata is used to augment image based classification.

FIG. 3 illustrates a relationship between a patch image and a field of view of a camera.

FIG. 4 depicts a process which may be used for cell classification.

FIG. 5 depicts a process in which obtaining metadata value(s) is performed prior to obtaining particle images.

FIG. 6 depicts an architecture which can be used by a deep learning model to classify a particle.

FIG. 7 depicts a stage which may be included in the architecture of FIG. 6.

FIG. 8 illustrates a method which can be used to incorporate metadata into particle classification.

FIG. 9 illustrates a method for training classifiers which would utilize both images and metadata.

FIG. 10 illustrates a method which could be used in training a classifier model such as could be implemented using a neural network.

FIG. 11 illustrates a method which may be performed in training a classifier which comprises a plurality of classification algorithms.

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### DETAILED DESCRIPTION

The present disclosure relates to apparatus, systems, compositions, and methods for analyzing a sample containing particles. In one embodiment, the disclosure relates to an automated particle imaging system which comprises an analyzer which may be, for example, a visual analyzer. In some embodiments, the visual analyzer may further comprise a processor to facilitate automated analysis of the images.

According to some aspects of this disclosure, a biological analyzer system comprising a visual analyzer may be provided for obtaining images of a sample comprising particles suspended in a liquid. Such a system may be useful, for example, in characterizing particles in biological fluids, such as detecting and quantifying erythrocytes, reticulocytes, nucleated red blood cells, platelets, and white blood cells, including white blood cell differential counting, categorization and subcategorization and analysis. Other similar uses such as characterizing blood cells from other fluids are also contemplated.

The analysis of blood cells in a blood sample is an exemplary application for which the subject matter is particularly well suited, though other types of body fluid samples may be used. For example, aspects of the disclosed technology may be used in analysis of a non-blood body fluid sample comprising blood cells (e.g., white blood cells and/or red blood cells), such as serum, bone marrow, lavage fluid, effusions, exudates, cerebrospinal fluid, pleural fluid, peritoneal fluid, and amniotic fluid. It is also possible that the sample can be a solid tissue sample, e.g., a biopsy sample that has been treated to produce a cell suspension. The sample may also be a suspension obtained from treating a fecal sample. A sample may also be a laboratory or production line sample comprising particles, such as a cell culture sample. The term sample may be used to refer to a sample obtained from a patient or laboratory or any fraction, portion or aliquot thereof. The sample can be diluted, divided into portions, or stained in some processes.

In some aspects, samples are presented, imaged and analyzed in an automated manner. In the case of blood samples, the sample may be substantially diluted with a suitable diluent or saline solution, which reduces the extent to which the view of some cells might be hidden by other cells in an undiluted or less-diluted sample. The cells can be treated with agents that enhance the contrast of some cell aspects, for example using permeabilizing agents to render cell membranes permeable, and histological stains to adhere in and to reveal features, such as granules and the nucleus. In some cases, it may be desirable to stain an aliquot of the sample for counting and characterizing particles which include reticulocytes, nucleated red blood cells, and platelets, and for white blood cell differential, characterization and analysis. In other cases, samples containing red blood cells may be diluted before introduction to the flow cell and/or imaging in the flow cell or otherwise.

The particulars of sample preparation apparatus and methods for sample dilution, permeabilizing and histological staining, generally may be accomplished using precision pumps and valves operated by one or more programmable controllers. Examples can be found in patents such as U.S. Pat. No. 7,319,907. Likewise, techniques for distinguishing among certain cell categories and/or subcategories by their attributes such as relative size and color can be found in U.S. Pat. No. 5,436,978 in connection with white blood cells. The disclosures of these patents are hereby incorporated by reference in their entirety.

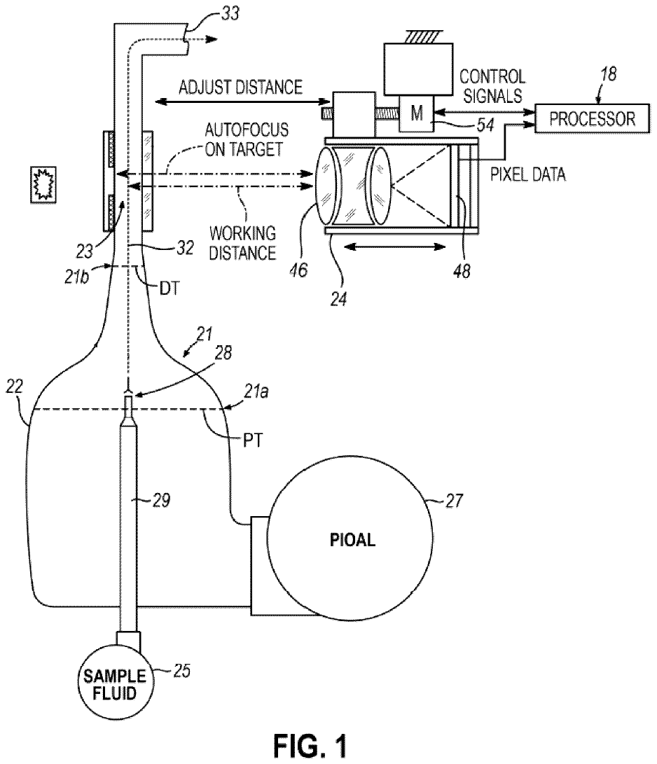

Turning now to the drawings, FIG. 1 schematically shows an exemplary flow cell 22 for conveying a sample fluid through a viewing zone 23 of a high optical resolution imaging device 24 in a configuration for imaging microscopic particles in a sample flow stream 32 using digital image processing. Flow cell 22 is coupled to a source 25 of sample fluid which may have been subjected to processing, such as contact with a particle contrast agent composition and heating. Flow cell 22 is also coupled to one or more sources 27 of a particle and/or intracellular organelle alignment liquid (PIOAL), such as a clear glycerol solution having a viscosity that is greater than the viscosity of the sample fluid.

The sample fluid is injected through a flattened opening at a distal end 28 of a sample feed tube 29, and into the interior of the flow cell 22 at a point where the PIOAL flow has been substantially established resulting in a stable and symmetric laminar flow of the PIOAL around/surrounding (e.g., circumferentially in a circular cross-sectional arrangement, or surrounding a plurality of sides of in a non-circular (e.g., rectangular) cross-sectional arrangement) the ribbon-shaped sample stream. The sample and PIOAL streams may be supplied by precision metering pumps that move the PIOAL with the injected sample fluid along a flowpath that narrows substantially. The PIOAL envelopes and compresses the sample fluid in the zone 21 where the flowpath narrows. Hence, the decrease in flowpath thickness at zone 21 can contribute to a geometric focusing of the sample stream 32. The sample fluid ribbon 32 is enveloped and carried along with the PIOAL downstream of the narrowing zone 21, passing in front of, or otherwise through the viewing zone 23 of, the high optical resolution imaging device 24 where images are collected, for example, using a CCD 48. In this way, flow imaging is performed where images from the flowing sample stream and the cellular material contained therein are collected. Processor 18 can receive, as input, pixel data from CCD 48. The sample fluid ribbon flows together with the PIOAL to a discharge 33.

As shown here, the narrowing zone 21 can have a proximal flowpath portion 21a having a proximal thickness PT and a distal flowpath portion 21b having a distal thickness DT, such that distal thickness DT is less than proximal thickness PT. The sample fluid can therefore be injected through the distal end 28 of sample tube 29 at a location that is distal to the proximal portion 21a and proximal to the distal portion 21b. Hence, the sample fluid can enter the PIOAL envelope as the PIOAL stream is compressed by the zone 21, wherein the sample fluid injection tube has a distal exit port through which sample fluid is injected into flowing sheath fluid, the distal exit port bounded by the decrease in flowpath size of the flow cell.

The digital high optical resolution imaging device 24 with objective lens 46 is directed along an optical axis that intersects the ribbon-shaped sample stream 32. The relative distance between the objective 46 and the flow cell 33 is variable by operation of a motor drive 54, for resolving and collecting a focused digitized image on a photosensor array. Additional information regarding the construction and operation of an exemplary flow cell such as shown in FIG. 1 is provided in U.S. Pat. No. 9,322,752, entitled “Flow cell Systems and Methods for Particle Analysis in Blood Samples,” filed on Mar. 17, 2014, the disclosure of which is hereby incorporated by reference in its entirety. Descriptions of approaches which may be used for focusing in an imaging system such as shown in FIG. 1 are provided in Published App. No. 2024/0357232 titled “Focus Quality Determination through Multi-Layer Processing,” filed on Jun. 11, 2024, U.S. Pat. No. 9,857,361 titled “Flowcell, Sheath fluid, and Autofocus Systems and Methods for Particle Analysis in Urine Samples”, filed on Mar. 17, 2014, U.S. Pat. No. 10,705,008 titled “Autofocus Systems and Methods for Particle Analysis in Blood Samples”, filed on Mar. 17, 2014, U.S. Pat. No. 10,705,011, titled “Dynamic Focus System and Methods”, filed Oct. 5, 2017, and international application WO2023/150064 titled “Measure Image Quality of Blood Cell Images”, filed Jan. 27, 2023, the disclosures of each of which are hereby incorporated by reference in their entirety.

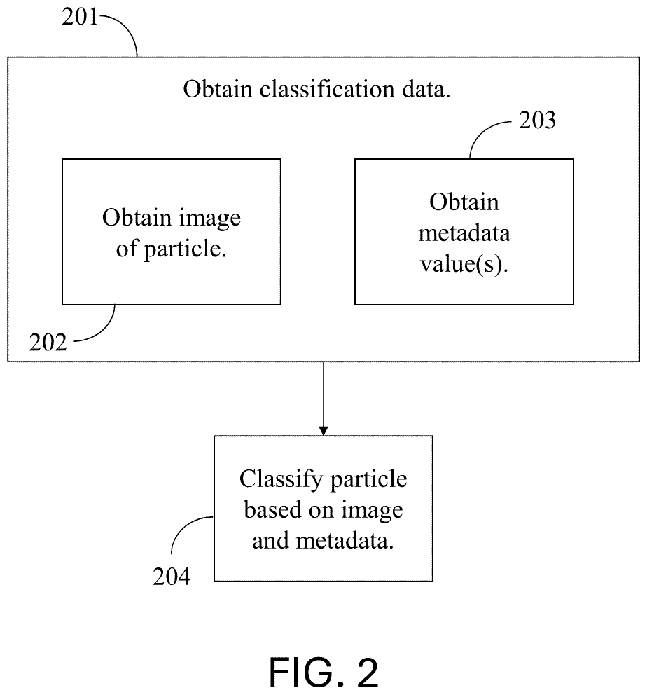

Once cell images have been captured (e.g., in a system such as illustrated in FIG. 1), those images can be used to classify the cells they depict, such as using techniques described in international patent application WO 2024/138116, published Jun. 27, 2024 and titled “Multi-Level Image Classifier for Blood Cell Images” and/or international patent application WO/2024,138139, published Jun. 27, 2024 for “Population Based Cell Classification,” the disclosures of which are hereby incorporated by reference in their entirety. Additionally, using the technology described herein, other data than cell images (referred to herein as metadata) may be integrated into the classification process as well. An example of a method which uses metadata to augment image based classification is shown in FIG. 2. In that method, a set of classification data would be obtained 201. This may include obtaining 202 an image of a particle from a biological sample (e.g., using a system such as that illustrated and described in the context of FIG. 1) as well as obtaining 203 metadata value(s). These may be one or more values which correspond to the particle from the biological sample, such as a focus quality of the image depicting the particle, time elapsed between acquisition of the sample containing the particle and the image depicting the particle being captured, or other metadata values such as are described herein. One the classification data had been obtained 201, the particle depicted in the image may be classified 204 based on both the image and the metadata. This classification 204 may be performed in a variety of manners, examples of which are described below.

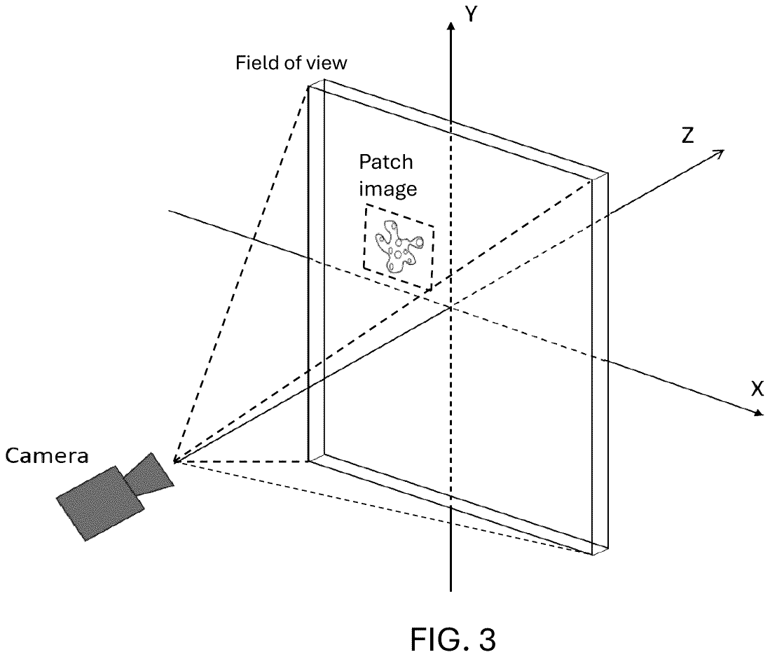

Turning next to FIG. 3, that figure illustrates a relationship between a type of image referred to as a patch image, and a field of view of a camera, which relationship may be used for metadata in some implementations of the disclosed technology. As shown in FIG. 3, when a camera captures an image, it may capture a field of view of which particle(s) to be classified are only a small portion. Accordingly, in some cases, obtaining 202 an image of a particle from a biological sample may comprising obtaining 202 a patch image, such as by using object detection routines to identify a particle to be classified and then cropping the field of view to exclude pixels other than those depicting that particle. Other types of processing steps (e.g., size normalization, color format conversion, etc.) may also be performed in in obtaining 202 a patch image, thereby ensuring that the patch image is suitable for processing using the particular embodiment under consideration.

In a case where obtaining 202 the image comprises obtaining 202 a patch image, a variety of types of metadata may be used to address the relationship between the patch image and the overall field of view. For example, it is possible that coordinates (e.g., X, Y coordinates) of a patch image in the field of view may be used as metadata so as to potentially account for nonuniformity across the field of view (e.g., if a patch image's brightness, contrast, hue, saturation, and/or noise level vary depending on position). Similarly, it is also possible that a blank image—e.g., an image patch at the same location as an obtained patch image when no cell is present—can be used as metadata for a patch image, such as by providing a baseline representation of the camera's field of view at the relevant location. Other approaches to using the context of an image as metadata are also possible, and may be included in some implementations of the disclosed technology. For example, just as the location in space of a patch image can be used as metadata, a location in time (e.g., a frame index) of an image that is part of a sequence of images may be used as metadata as well. Accordingly, the above description of the use of a relationship between a patch image and a field of view should be understood as being illustrative only, and should not be treated as limiting.

In addition to, or as an alternative to, using metadata from an image's context (e.g., location of a patch image in field of view, index of an image from a sequence of images) some implementations of the disclosed technology may use metadata derived from analysis of the images themselves. For example, given that focusing quality can significantly alter the characteristics of a cell image, some implementations may use an image's focus quality (e.g., as determined using technology such as described in U.S. Pat. No. 12,452,532, titled “Focus Quality Determination through Multi-Layer Processing,” filed on Jun. 11, 2024, the disclosure of which is hereby incorporated by reference in its entirety) as metadata for classifying a particle (e.g., a red blood cell or a white blood cell) included in that image. Similarly, in cases where an image is of a particle prepared through use of a staining compound (e.g., a white blood cell, which might be stained using techniques and materials such as described in U.S. Pat. No. 9,279,750, entitled “Method and Composition for Staining and Sample Processing,” issued on Mar. 8, 2016, the disclosure of which is hereby incorporated by reference in its entirety) the staining quality (e.g., as may be determined by comparing the distribution of pixel saturation values for the image with predefined pixel saturation distributions for various cell types such as neutrophils or eosinophils) may be used as metadata for cell classification. As another example, the front facing alignment for a red blood cell (e.g., as may be measured using the techniques disclosed in international patent application PCT/US24/46596 titled “Using Trained Machine Learning Models to Determine Alignment Characteristics,” filed on Sep. 13, 2024, the disclosure of which is hereby incorporated by reference in its entirety) may be used as a type of metadata in some implementations. Other types of metadata may also be derived from analyzing a cell image, such as characteristics of a cell the image depicts (e.g., size of the cell as depicted, nucleus-to-cytoplasm ratio for white blood cells, or tilting, spikiness, circularity, or tumbling measurements for red blood cells) and these characteristics may be used in classifying a depicted particle, either in addition to, or as alternatives to, one or more of the other types of metadata described herein. Accordingly, the description of using characteristics like focus or stain quality as metadata for cell classification should be understood as being illustrative only, and should not be treated as limiting.

Types of metadata can include metadata unique to the particular cell-such as metadata associated with cell images or cell parameters, or sample level conditions associated with the overall sample, system, or operating environment associated with the imaging of the cells, and combinations thereof.

In one example, metadata may include a focusing or focal quality measurement associated with a cell image (e.g., as determined using technology such as described in U.S. Pat. No. 12,452,532, titled “Focus Quality Determination through Multi-Layer Processing,” filed on Jun. 11, 2024, U.S. Pat. No. 10,705,011, titled “Dynamic Focus System and Methods,” filed on Mar. 26, 2019, and/or U.S. published patent application 2024/0420489, titled “Measure Image Quality of Blood Cell Images,” filed on Jul. 26, 2024, the disclosures of which are hereby incorporated by reference in their entireties). Focal quality indicates whether the image is in focus, positively out of focus, or negatively out of focus. Poor focal quality may obscure morphological features of a cell, including edges, texture, nucleus boundaries, and intracellular structures, which may result in misclassification. Accordingly, focal quality may serve as an indicator of image reliability. In various embodiments, focal quality metadata may be used to determine whether a cell image is suitable for classification, to select an optimal classification algorithm trained for a specific focus condition, to weight classification confidence, or to exclude low-quality images from downstream analysis. Examples can include a focal score indicating focal quality where a numerical value is associated with good, or poor focal quality (e.g., a number between 0-1 where values closer to 1 represent good focal quality). Alternatively, the focal metadata can include a number indicating how in focus the image is which has negative values if the image is too close or too far, positive values for the alternative situation, and 0 would indicate a perfect focal state.

Metadata may also include spatial position information, such as X and Y coordinates of a patch image within a camera's field of view. Imaging systems may exhibit spatial non-uniformity, including variations in illumination, optical distortion, sensor sensitivity, or background noise across different regions of the field of view. As a result, cell images captured at different positions may exhibit different brightness, contrast, color balance, or noise characteristics. By incorporating positional metadata, the classification system may compensate for these variations, normalize image features, select region-specific processing parameters, or improve robustness against location-dependent artifacts.

Metadata may include temporal information, such as a frame index or timestamp indicating when a cell image was captured. Temporal metadata may reflect changes in imaging conditions over time, including illumination drift, temperature fluctuation, staining degradation, or mechanical instability. Additionally, temporal position may indicate sample flow dynamics and cell density variations. Such metadata may be used to adjust image preprocessing parameters, estimate sample condition changes, select time-dependent classifiers, or identify segments of data affected by transient disturbances.

In an example, metadata may include a blank image corresponding to the same spatial location as a cell image when no cell is present. A blank image represents the background signal, illumination profile, and sensor noise characteristics at that location. By comparing a cell image with its corresponding blank image, background subtraction, noise compensation, and illumination correction may be performed. This enables more accurate extraction of cellular features and reduces false variations caused by hardware-related artifacts.

Metadata may include a staining quality measurement associated with a cell image, particularly for stained white blood cells. Staining quality reflects a degree to which cellular components, such as nuclei or granules, are properly stained which affects the extent to which the images can be properly visualized. Insufficient or excessive staining may distort color distributions, obscure intracellular structures, or alter contrast between cellular regions. Staining quality as metadata can assist in analysis to see if the image is of sufficient quality for analysis or classification. By way of example, staining quality metadata may be used to select specialized classifiers, adjust color normalization parameters, weight classification outputs, or exclude inadequately stained images from analysis.

In an example, metadata may include nucleus-related image analysis, for instance a nucleus-to-cytoplasm ratio measurement for white blood cells. This ratio represents the relative size of the nucleus compared to the surrounding cytoplasm and may be a key morphological indicator for differentiating cell subtypes, such as lymphocytes, blasts, or monocytes. Incorporating this metadata enables the classification system to leverage biologically meaningful features that may not be reliably inferred from pixel-level data alone. The nucleus-to-cytoplasm ratio may be used, for example, as an independent classification feature, as an auxiliary input to a neural network, or as a constraint in post-processing.

Metadata may include measurements related to red blood cell orientation and morphology, such as front-facing alignment, tilting, spikiness, circularity, or tumbling behavior. These characteristics indicate whether the cell is properly oriented for imaging and whether its shape conforms to expected physiological patterns. Improper alignment or abnormal motion may be indicative of distorted projections or flowcell-related flow or performance issues such as partial occlusion. Such metadata may be used to identify reliably imaged cells, adjust classification confidence, select orientation-specific classifiers, or flag abnormal cells for further analysis.

Metadata may include system or sample level characteristics including ambient temperature, operational temperature, and module temperature associated with sample processing and imaging. Temperature variations may affect staining reactions, lysing efficiency, reagent performance, and optical stability. These effects may alter image characteristics such as color saturation, contrast, and structural clarity. By incorporating temperature metadata, the system may estimate staining effectiveness, compensate for environmental variability, select temperature-optimized classifiers, or adjust preprocessing algorithms.

Metadata may include sample age, defined as the elapsed time between sample collection and imaging, as well as storage conditions, such as room temperature or refrigerated storage. Prolonged storage or improper conditions may cause cellular degradation, morphological changes, or staining inconsistency. Sample age and storage metadata may therefore be used to assess sample viability, adjust classification thresholds, select aging-aware models, or exclude compromised samples from statistical analysis.

In an example, metadata may include the total number of cells acquired in a sample run or local cell density within the flowcell or in a particular region of the flowcell over time. High or low cell density may affect flow dynamics, overlap probability, staining efficiency, and imaging stability. For example, overcrowded conditions may be indicative of flowcell clogging or occlusion issues, while sparse conditions may reflect insufficient sample volume. Such metadata may be used to estimate overall sample quality, adjust confidence metrics, normalize population statistics, or modify classification strategies.

In an example, focal quality metadata may be used to select an optimal classification algorithm from a plurality of pretrained models. For example, a first classifier may be optimized for positively out-of-focus images, a second classifier for in-focus images, and a third classifier for negatively out-of-focus images. Upon determining the focal quality of a given cell image, the system may automatically select the classifier best suited for that focus condition, thereby improving classification accuracy and reducing error caused by defocus.

In an example, one or more metadata values, including focal quality, staining quality, orientation measurements, or nucleus-to-cytoplasm ratio, may be provided as additional inputs to a machine learning model. These metadata values may be concatenated with feature vectors generated from convolutional layers and supplied to one or more fully connected layers. By incorporating metadata directly into the learning process, the model may learn correlations between imaging conditions and classification outcomes, thereby producing more reliable predictions across varying conditions.

In some embodiments, metadata may be used to modify or validate classification results after an initial prediction has been generated. For example, if a focal quality measurement falls below a predefined threshold, a preliminary classification may be rejected or reclassified as low quality. Similarly, if staining quality and classification confidence both exceed predefined thresholds, the preliminary result may be accepted as final. This processing approach enables the system to reduce false positives and improve overall reliability.

For instance, focal quality (whether the image is in focus or not), can be indicative data to see if various cell types can even be classified properly (e.g., poor focal quality may make it hard for the system to appropriately classify the cell). Front facing alignment can be indicative data for certain blood cells (e.g., red blood cells) to see if they are oriented correctly and can be classified/sized correctly as a result. Staining quality assessment can be indicative data for white blood cells which are stained to visualize their interior/nucleus region to ensure that the white blood cells are being stained and can be analyzed correctly. Therefore, in one example, red blood cells can utilize one or more of front facing alignment and focal quality as metadata, while white blood cells can utilize one or more of focal quality and staining quality as metadata.

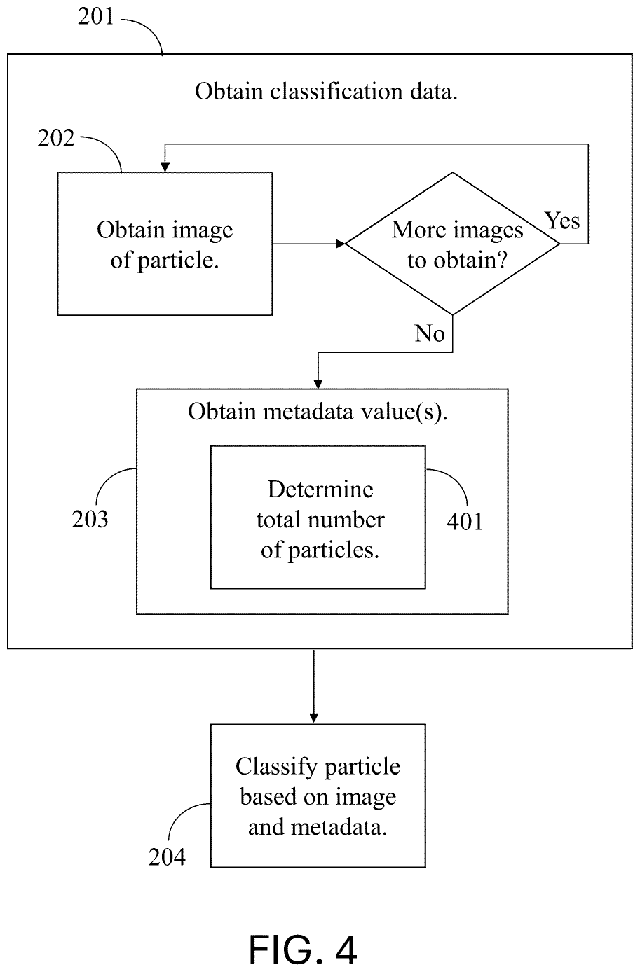

It is also possible that, in some implementations, data regarding the sample which contained an imaged cell may be used as metadata for cell classification. To illustrate, consider FIG. 4, which depicts a process which may be used for cell classification in some implementations. In that process, the step of obtaining 202 an image of a particle would be repeated until there were no further particle images to be obtained for that sample. For instance, in a case where a sample is being imaged as it flows through a flowcell in a system such as shown in FIG. 1, obtaining 202 particle images as illustrated in FIG. 4 may include capturing image frames of the flowcell until the sample stream for a sample had been completely flowed through the flowcell. After the particles images had been obtained 202, the metadata value(s) may be obtained 203 through performing steps which include determining 401 the total number of particles imaged for that sample (e.g., by counting the number of patch images extracted from field of view images captured while the sample stream was flowing through the flowcell). This total number of particles could then be used as metadata when one of the particles from the sample was being classified 204 based on the image of that particle and the corresponding metadata for the image depicting the particle.

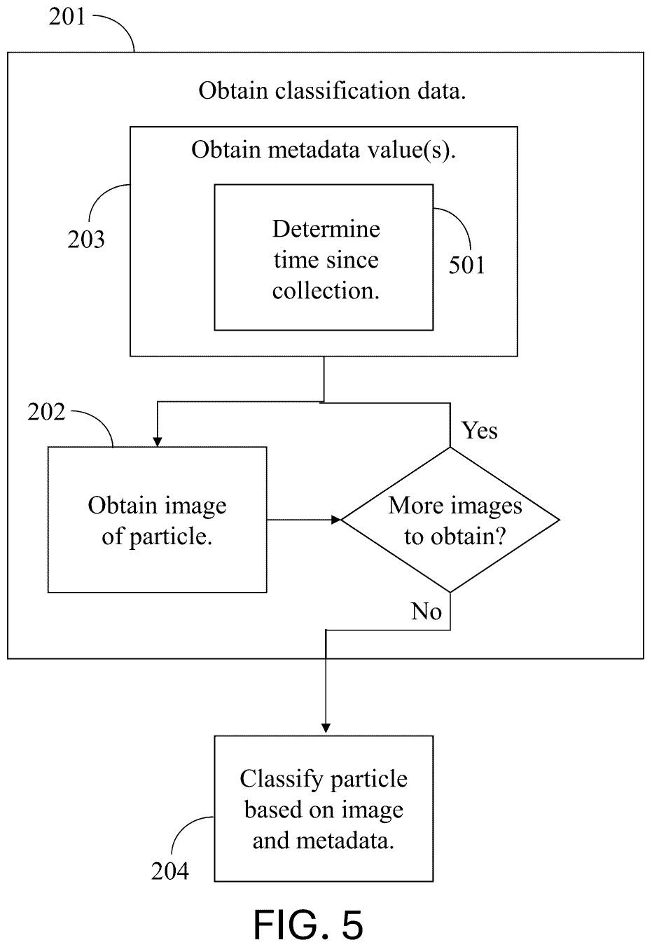

While FIG. 4 illustrates a process in which metadata regarding a sample which contained an imaged cell was obtained after multiple particle images, this should not be understood as implying that obtaining 203 metadata value(s) will necessarily take place after obtaining 401 one or more particle images. For example, FIG. 5 illustrates a process in which obtaining 203 metadata value(s) is performed prior to obtaining 203 particle images, and includes determining 501 the time elapsed between the sample being collected and it being processed by an analyzer such as a flowcell based system as shown in FIG. 1. Other types of metadata values may also be obtained 203 prior to obtaining 202 particle images. For example, whether the sample was stored at room temperature or in refrigerated storage may be obtained 203 prior to sample imaging and used as metadata in some cases. Similarly, in a case where the temperature of a module used for staining and/or lysing a sample is used as metadata for classifying images of particles in a stained and lysed sample stream, that metadata may be obtained 203 prior to the particle images. It is also possible that one or more metadata values may be obtained 203 simultaneously with the particle images, such as could be the case where the ambient temperature of the analyzer used to capture particle images was used as metadata. Combinations are also possible, in which some metadata values may be obtained prior to particle imaging, some metadata values may be obtained simultaneously with particle imaging, and some metadata values may be obtained after imaging is complete. Accordingly, the examples of metadata values being obtained before or after particle imaging which were described in the context of FIGS. 4 and 5 should be understood as illustrative, and should not be treated as limiting on the scope of protection provided by this document or any related document.

Just as there are a variety of different types of metadata which may be used in classifying 204 particles, various implementations of the disclosed technology may use a variety of different approaches to incorporating that metadata into the classification. For example, in some cases, a metadata value may be used to select a particular algorithm to use in classifying a particular particle image. For instance, with this type of approach, a system could be implemented with three different classification algorithms, one optimized for positively out of focus images (e.g., a convolutional neural network classifier trained on annotated positively out of focus cell images), one optimized for in focus images, and one optimized for negatively out of focus images. Then, when classifying 204 a cell image, the focus of that image could be used as metadata to select the algorithm which would be expected to give the best result, thereby improving the overall accuracy the sample's particle classifications. This same type of approach could also be used with other types of metadata values. For example, there could be an implementation which included different classifiers for lightly or heavily stained images, and the staining quality, which may be determined directly (e.g., based on comparing the distribution of pixel saturation values for an image with predefined pixel saturation distributions for various cell types such as neutrophils or eosinophils) or indirectly (e.g., based on operational temperature, ambient temperature, and the number of cells acquired in a sample run). Other approaches to using metadata for selecting a classification algorithm (e.g., having different classifiers for various combinations of staining quality and focus, having different classifiers for different levels of delay between when a sample is collected and when it is analyzed, etc.) are also possible, and could be used in various implementations of the disclosed technology.

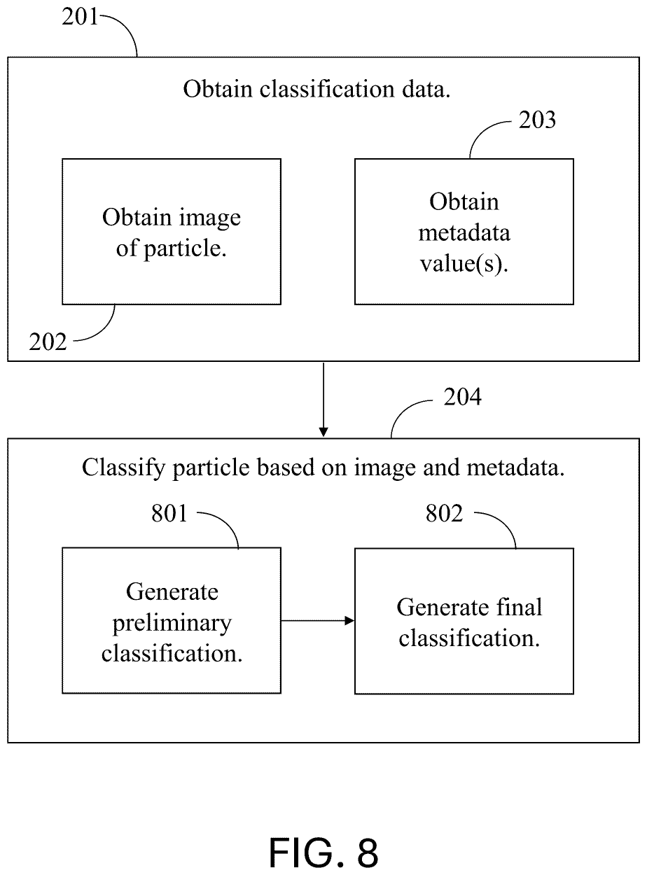

Another approach which can be used to incorporate metadata into particle classification is to use metadata to alter a particle classification after it has been generated. A method showing how this type of approach may be implemented is illustrated in FIG. 8. In that method, initially, a preliminary classification would be generated 801. To illustrate how this could be done, consider an implementation where the disclosed technology is used for WBC classification. To support this type of implementation, a machine learning classifier could be trained using only images of white blood cells and their associated ground truth labels. Then, when a WBC image was captured, it could be provided to the trained classifier, and the classification provided by that classifier could be used as the preliminary classification in a method such as shown in FIG. 8. Then, one or more metadata values may be used to generate 802 a final classification for the particle. For example, focusing quality and/or staining quality measurements may be evaluated to determine if they satisfy one or more requirements (e.g., they may be compared with respective quality thresholds). If the requirements are satisfied, then generating 802 the final classification may be performed by treating the preliminary classification as the final classification. Alternatively, if one or more requirements was not satisfied, then generating 802 the final classification may be performed by reclassifying the particle into a “low quality” category, which could prevent it from being used in subsequent processing (e.g., by excluding it from subsequent calculations of what percentage of cells in the sample were accounted for by each class).

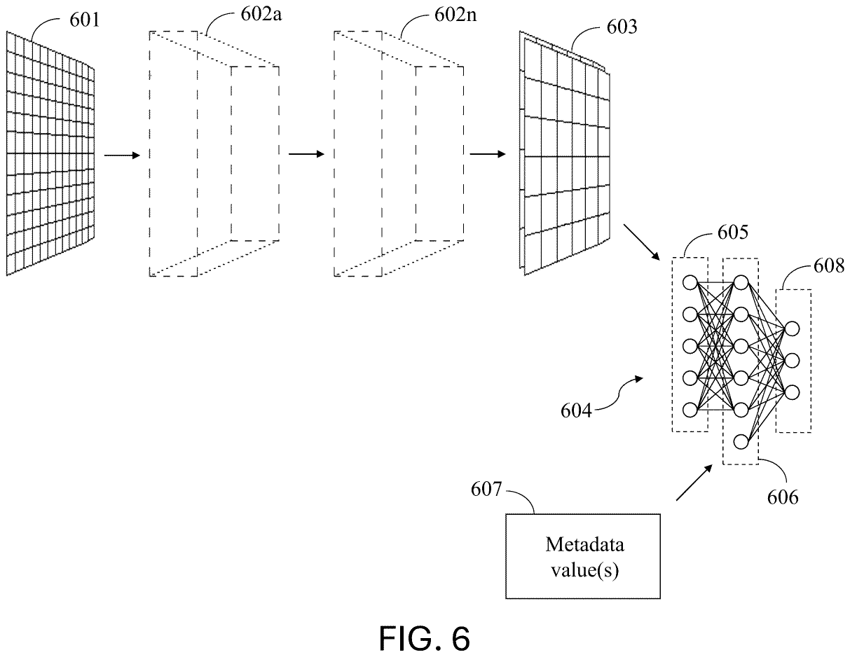

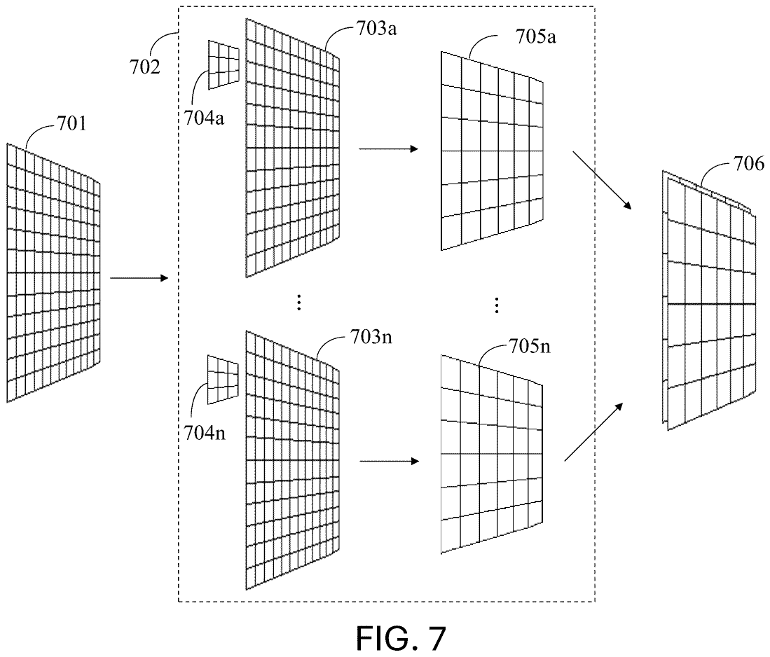

Yet another approach which can be used to incorporate metadata into particle classification is to use the metadata as an additional input to a model which is used to classify a particle. To illustrate how this type of approach may be implemented, consider FIGS. 6-7, which depict an architecture which can be used by a deep learning model to classify a particle based both on an image of that particle and one or more metadata values. In that architecture, an input image 601 would be analyzed in a series of stages 602a-602n, which are illustrated in more detail in FIG. 7. As shown in FIG. 7, an input (which, in the initial stage 602a would be the input image 601 and otherwise would be the output of the preceding stage) is provided to a stage 702 where it would be processed to generate one or more transformed images 703a-703n. This processing may include convolving the input 701 with a set of filters 704a-704n, each of which would identify a type of feature from the underlying image, and then passing the output of the convolution through a function (referred to as an activation function) to determine the output that would be included in the transformed image. For instance, as a simple example, convolving an image with the filter shown in table 1 and then passing the result through a rectified linear unit (ReLU) activation function could generate a transformed image capturing the edges from the input image 701 with zero values being used for any outputs which would otherwise be negative.

TABLE 1

[−1 −1 −1]
[−1 8 −1]
[−1 −1 −1]

As shown in FIG. 7, in addition to generating transformed images 703a-703n a stage may also generate a pooled image 705a-705n for each of the transformed images 703a-703n. This may be done, for example, by organizing the appropriate transformed images into a set of regions, and then replacing the values in that region with a single value, such as the maximum value for the region or the average of the values for the region. The result would be a pooled image whose resolution would be reduced relative to its corresponding transformed image based on the size of the regions it was split into (e.g., if the transformed image had N×N dimensions, and it was split into 2×2 regions, then the pooled image would have size (N/2)×(N/2)). These pooled images 705a-705n could then be combined into a single output image 706, in which each of the pooled images 705a-705n is treated as a separate channel in the output image 706. The output image 706 can then be provided as input to the next stage as shown in FIG. 6.

Returning to the discussion of FIG. 6, after a final output image 603 has been created through the various stages 602a-602n of processing the final output image 603 could be provided as an input to a neural network 604. This may be done, for example, by providing the value of each channel of each pixel in the output image 603 to an input node of a first fully connected layer 605 (i.e., a layer which each node is connected to every node in a previous layer). The output of this layer may then be provided as input to another fully connected layer 605, and this may be repeated for one or more fully connected layers, including a layer 605 which includes input nodes both for the outputs of the preceding layer as well as for one or more metadata values 607 (e.g., if this type of layer was preceded by a layer with 200 outputs, then it could have 200+n inputs, one for each output of the previous layer, and one for each of n metadata values). Finally, a layer 608 could be provided whose output nodes could each be treated as corresponding to a type of particle, such as monocyte, lymphocyte, basophil, etc., and the output node with the highest value could be treated as the classification for the particle depicted in the original input image 601.

It should be understood that, while FIGS. 6 and 7 and the associated discussion provided examples of machine learning classifiers which could use both an image and associated metadata for particle classification, there are a variety of different classifiers which could be used for that purpose. For instance, the approach described in the context of FIGS. 6-7 could be implemented using various numbers and dimensions of layers. For example, a machine learning classifier could be implemented using the numbers and dimensions of layers and the activation function described below in table 2.

TABLE 2

| Layer | Description |
|---|---|
| 1 | Input layer that takes a normalized 128 × 128 × 3 RGB |
| | image |
| 2a | Convolutional layer (filter size = 5, number of |
| | filters = 64, ReLU activation) |
| 2b | Max pooling layer resulting in 64 × 64 × 64 output |
| 3a | Convolutional layer (filter size = 5, number of |
| | filters = 128, ReLU activation) |
| 3b | Max pooling layer resulting in 32 × 32 × 128 output |
| 4a | Convolutional layer (filter size = 5, number of |
| | filters = 256, ReLU activation) |
| 4b | Max pooling layer resulting in 16 × 16 × 256 output |
| 5a | Convolutional layer (filter size = 5, number of |
| | filters = 512, ReLU activation) |
| 5b | Max pooling layer resulting in 8 × 8 × 512 output |
| 6a | Convolutional layer (filter size = 5, number of |
| | filters − 512, ReLL activation) |
| 6b | Max pooling layer resulting in 4 × 4 × 512 output |
| 7 | Fully connected layer with 200 outputs |
| 8 | Fully connected layer with 200 + n inputs (e.g., |
| | 200 1 inputs if there is 1 metadata value (e.g., |
| | focusing or staining quality), 202 inputs if there |
| | are 2 metadata values (e.g., focusing and |
| | staining quality), etc.) and 8 outputs (assumes |
| | 8 classifications for imaged particles) |

However, other dimensions may be used. For example, the input image may have dimensions A×B pixels on a side, where A and B each range from tens to hundreds. Similarly, the convolution filters may have sizes other than five, such as filters as small as 3×3 or as large as 9×9 (or larger). The number of convolution+pooling layer pairs may also vary from several to tens (or more) as could the number of fully connected layers. The number of outputs of the fully connected layers could also vary from tens to thousands, and the metadata may be added at any of the fully connected layers, rather than being required to be added only at the last fully connected layer, as shown in table 2. Indeed, it is also possible that the metadata may be added in layers other than the fully connected layers, such as by adding one or more additional channels to the input image, and populating the values for those channels with metadata values to use in classification (e.g., a blank image may be concatenated to an input image by adding the values of the pixels in the blank image as additional channels in the input image). Indeed, classifiers other the machine learning classifiers such as shown in FIGS. 6 and 7 may also be used to classify particles based on both images and metadata. For example, in a decision tree classifier, there may be decision nodes added which would be controlled wholly or partially by metadata (e.g., if stain quality is less than a threshold value, go down decision tree branch A, otherwise, go down decision tree branch B). Accordingly, the example machine learning classifiers described above in the context of FIGS. 6 and 7, as well as the variations on those classifiers, should be understood as being illustrative only, and should not be treated as limiting.

Variations on the above approaches for integrating metadata into particle classification are also possible, and could be implemented without undue experimentation by those of skill in the art based on this disclosure. For example, while the approaches described above were described separately, it is possible that two or more of those approaches may be combined in some implementations. For instance, in some cases staining or focusing quality metadata could be used to select a classifier to use in classifying a particle, and then that classifier might incorporate a blank image as metadata in actually classifying the particle in question. Similarly, it is also possible that acts which are described separately may be combined in some implementations. For instance, generating 801 a preliminary classification may be combined with obtaining 203 metadata values by generating the preliminary classification using a classifier which would provide a probability associated with the preliminary classification, and then treating the associated probability as a metadata value for the purpose of generating 802 a final classification for the imaged particle. Other variations, such as the use of different types of metadata and/or different types of classifiers are also possible, and so the above examples of variations, like the disclosure which preceded them, should be understood as being illustrative only, and should not be treated as limiting.

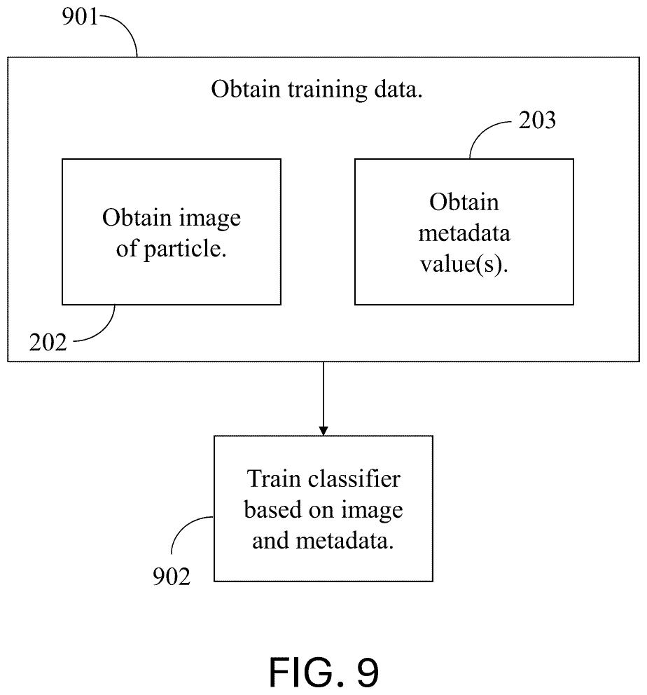

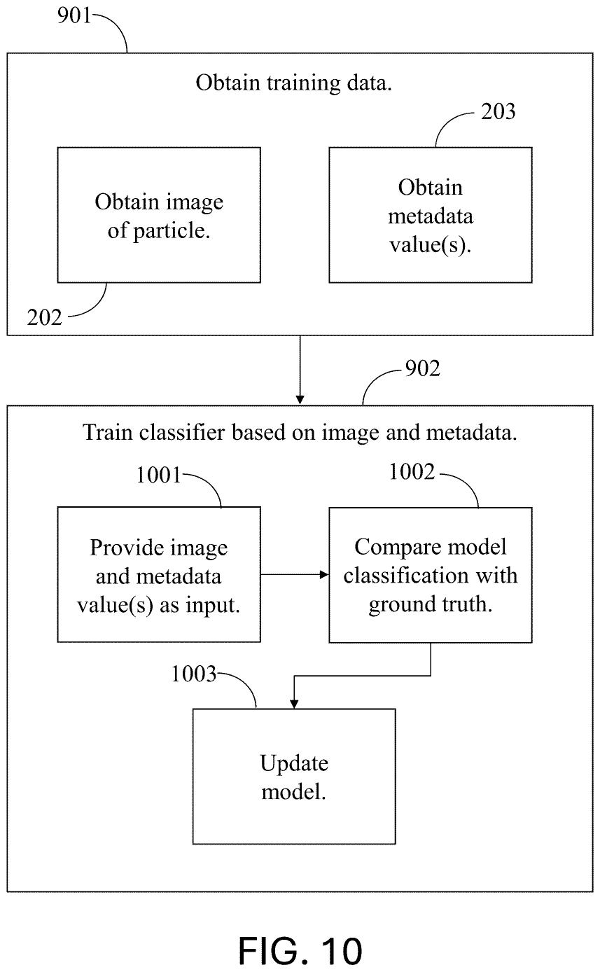

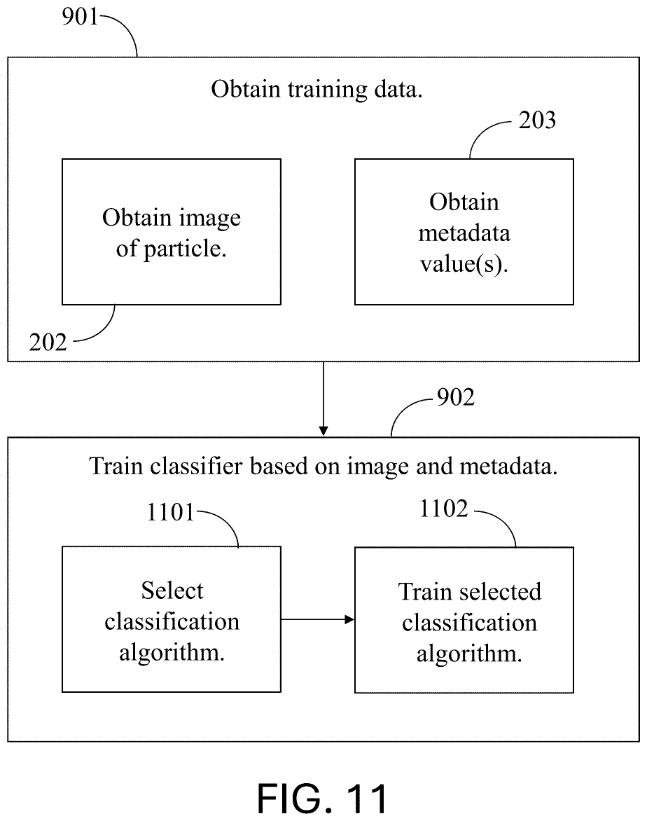

The disclosed technology may also be applied in methods of training classifiers which would utilize both images and metadata in particle classification. An example of such a method is shown in FIG. 9. In that figure, initially training data would be obtained 901. This may be performed in a manner similar to what was described in the context of FIG. 2 for obtaining 201 classification data (e.g., obtaining 202 an image of a particle and obtaining 203 corresponding metadata values for that particle. This training data can then be used to train 902 the classifier. Just as there are a variety of ways in which classification data can be used in classifying an imaged particle, there are a variety of ways in which training data can be used to train a classifier, examples of which are discussed below in the context of FIGS. 10-11.

Turning first to FIG. 10, that figure illustrates a method which may be used in training a classifier model such as could be implemented using the neural network architecture of FIGS. 6 and 7. As shown in that figure, this training process may include providing 1001 a particle image and at least one corresponding metadata value to the classifier model. The classification result from the classifier may then be compared 1002 with a ground truth classification for the particle (e.g., a known correct particle created by a human annotator for the purpose of training), and any difference between the classification from the classifier and the ground truth classification could be used to update 1003 the classification model (e.g., weight values in the classifier model could be updated to minimize a loss function relative to the ground truth value, such as cross entropy loss). It is also possible that a training method such as shown in FIG. 10 may be performed using a large number of images, with those images split into subsets, and the training being performed multiple times with a different subset of images being held back for validation each time (i.e., K-fold cross validation). In this way, performance metrics from each training instance can be averaged to verify the classifier's performance and, assuming the performance is acceptable, a final trained version of the classifier (e.g., whichever trained classifier had the best individual performance) can be used to make inferences (i.e., classify cell images) in production.

Another approach which may be taken in training a classifier is illustrated in FIG. 11, which illustrates a method which may be performed when the classifier comprises a plurality of classification algorithms which are selectable based on metadata values (e.g., a classifier which would be used for positively out of focus images, a classifier which would be used with negatively out of focus images, etc.). As shown in that figure, to train such a classifier, a classification algorithm may be selected 1101 for training, such as by identifying which of the classification algorithms best matched the metadata values corresponding to a particle depicted in a training image. The selected algorithm may then be trained 1102 based on the training image and its associated metadata values, such as, in the case where the classification algorithm was application of a neural network model, by training that algorithm using a method such as shown in FIG. 10 and described in the corresponding text. In this way, implementations which include multiple algorithms optimized for images having different characteristics (as reflected in their metadata) could be trained so that each of those algorithms was able to perform appropriately with the type of images it was optimized for.

As a further illustration of potential implementations and applications of the disclosed technology, the following examples are provided of non-exhaustive ways in which the teachings herein may be combined or applied. It should be understood that the following examples are not intended to restrict the coverage of any claims that may be presented at any time in this application or in subsequent filings of this application. No disclaimer is intended. The following examples are being provided for nothing more than merely illustrative purposes. It is contemplated that the various teachings herein may be arranged and applied in numerous other ways. It is also contemplated that some variations may omit certain features referred to in the below examples. Therefore, none of the aspects or features referred to below should be deemed critical unless otherwise explicitly indicated as such at a later date by the inventors or by a successor in interest to the inventors. If any claims are presented in this application or in subsequent filings related to this application that include additional features beyond those referred to below, those additional features shall not be presumed to have been added for any reason relating to patentability.

### Example 1

A method comprising: obtaining an image of a particle from a biological sample; obtaining one or more metadata values corresponding to the particle from the biological sample; and classifying the particle from the biological sample based on the image and on the one or more metadata values.

### Example 2

The method of example 1, wherein: the image of the particle from the biological sample is a patch image having a location in a field of view; and the one or more metadata values comprise: the location of the patch image in the field of view; and/or values of pixels in a blank image patch located at the location of the image of the particle from the biological sample in the field of view.

### Example 3

The method of any of examples 1-2, wherein: the image of the particle from the biological sample has an index in a sequence of images of the biological sample; and the one or more metadata values comprise the index of the image of the particle in the biological sample in the sequence of images of the biological sample.

### Example 4

The method of any of examples 1-3, wherein the one or more metadata values comprise at least one value derived from the image of the particle from the biological sample.

The method of example 4, wherein the at least one value derived from the image of the particle from the biological sample comprises: a focus quality of the image of the particle in the biological sample; a staining quality of the image of the particle in the biological sample; a front facing orientation of the particle; and/or a measurement of the particle.

### Example 6

The method of any of examples 1-5, wherein the one or more metadata values comprise at least one value which corresponds to the biological sample.

### Example 7

The method of example 6, wherein the one or more metadata values comprise: a total number of particles depicted in images taken during analysis of the biological sample; and/or a time elapse following the biological sample being acquired from a patient.

### Example 8

The method of any of examples 1-7, wherein classifying the particle from the biological sample based on the image and on the one or more metadata values comprises selecting a classification algorithm for classifying the particle based on at least one of the one or more metadata values.

### Example 9

The method of any of examples 1-8, wherein classifying the particle from the biological sample based on the image and on the one or more metadata values comprises providing both the image and at least one of the one or more metadata values to a classification model as input.

### Example 10

The method of example 9, wherein: the classification model is a convolutional neural network comprising one or more convolutional layers and one or more fully connected layers; and providing both the image and at least one of the one or more metadata values to the classification model as input comprises: providing the image of the particle from the biological sample to a convolutional layer as input; and providing at least one of the one or more metadata values to a fully connected layer as input.

### Example 11

The method of any of examples 1-10, wherein: the method comprises generating a preliminary classification for the particle from the biological sample based on the image; and classifying the particle from the biological sample based on the image and on the one or more metadata values comprises generating a final classification for the particle from the biological sample based on at least one of the one or more metadata values.

### Example 12

The method of any of examples 1-11, wherein obtaining the image of the particle from the biological sample comprises flowing the biological sample through a flowcell and imaging the particle when it is in the flowcell using a camera.

### Example 13

A non-transitory computer readable medium storing instructions for performing the method of any of examples 1-12.

### Example 14

A system comprising: one or more processors; and a non-transitory computer readable medium having stored thereon instructions for performing the method of any of examples 1-12 when executed using the one or more processors.

### Example 15

An analyzer comprising: one or more processors; the camera; the flowcell; and a non-transitory computer readable medium having stored thereon instructions for performing the method of example 12 when executed using the one or more processors.

A system comprising: one or more processors; and a non-transitory computer readable medium having stored thereon instructions for performing a set of acts when executed using the one or more processors, the set of acts comprising: obtaining an image of a particle from a biological sample; obtaining one or more metadata values corresponding to the particle from the biological sample; and classifying the particle from the biological sample based on the image and on the one or more metadata values.

### Example 17

The system of example 16, wherein: the image of the particle from the biological sample is a patch image having a location in a field of view; and the one or more metadata values comprise: the location of the patch image in the field of view; and/or values of pixels in a blank image patch located at the location of the image of the particle from the biological sample in the field of view.

### Example 18

The system of any of examples 16-17, wherein: the image of the particle from the biological sample has an index in a sequence of images of the biological sample; and the one or more metadata values comprise the index of the image of the particle in the biological sample in the sequence of images of the biological sample.

### Example 19

The system of any of examples 16-18, wherein the one or more metadata values comprise at least one value derived from the image of the particle from the biological sample.

### Example 20

The system of example 19, wherein the at least one value derived from the image of the particle from the biological sample comprises: a focus quality of the image of the particle in the biological sample; a staining quality of the image of the particle in the biological sample; a front facing orientation of the particle; and/or a measurement of the particle.

The system of any of examples 16-20, wherein the one or more metadata values comprise at least one value which corresponds to the biological sample.

### Example 22

The system of example 21, wherein the one or more metadata values comprise: a total number of particles depicted in images taken during analysis of the biological sample; and/or a time elapse following the biological sample being acquired from a patient.

### Example 23

The system of any of examples 16-22, wherein classifying the particle from the biological sample based on the image and on the one or more metadata values comprises selecting a classification algorithm for classifying the particle based on at least one of the one or more metadata values.

### Example 24

The system of any of examples 16-23, wherein classifying the particle from the biological sample based on the image and on the one or more metadata values comprises providing both the image and at least one of the one or more metadata values to a classification model as input.

### Example 25

The system of example 24, wherein: the classification model is a convolutional neural network comprising one or more convolutional layers and one or more fully connected layers; and providing both the image and at least one of the one or more metadata values to the classification model as input comprises: providing the image of the particle from the biological sample to a convolutional layer as input; and providing at least one of the one or more metadata values to a fully connected layer as input.

The system of any of examples 16-25, wherein: the set of acts comprises generating a preliminary classification for the particle from the biological sample based on the image; and classifying the particle from the biological sample based on the image and on the one or more metadata values comprises generating a final classification for the particle from the biological sample based on at least one of the one or more metadata values.

### Example 27

The system of any of examples 16-26, wherein obtaining the image of the particle from the biological sample comprises flowing the biological sample through a flowcell and imaging the particle when it is in the flowcell using a camera.

### Example 28

A non-transitory computer readable medium storing instructions for performing the set of acts of the instructions stored on the non-transitory computer readable medium of any of examples 16-27.

### Example 29

A method comprising performing the set of acts of the instructions stored on the non-transitory computer readable medium of any of examples 16-27.

### Example 30

An analyzer comprising: one or more processors; the camera; the flowcell; and a non-transitory computer readable medium having stored thereon instructions for performing the set of acts of the instructions stored on the non-transitory computer readable medium of example 27.

### Example 31

An analyzer comprising: one or more processors; a camera; a flowcell; and a non-transitory computer readable medium having stored thereon instructions for performing a set of acts when executed using the one or more processors, the set of acts comprising: obtaining an image of a particle from a biological sample; obtaining one or more metadata values corresponding to the particle from the biological sample; and classifying the particle from the biological sample based on the image and on the one or more metadata values.

### Example 32

The analyzer of example 31, wherein: the image of the particle from the biological sample is a patch image having a location in a field of view; and the one or more metadata values comprise: the location of the patch image in the field of view; and/or values of pixels in a blank image patch located at the location of the image of the particle from the biological sample in the field of view.

### Example 33

The analyzer of any of examples 31-32, wherein: the image of the particle from the biological sample has an index in a sequence of images of the biological sample; and the one or more metadata values comprise the index of the image of the particle in the biological sample in the sequence of images of the biological sample.

### Example 34

The analyzer of any of examples 31-33, wherein the one or more metadata values comprise at least one value derived from the image of the particle from the biological sample.

### Example 35

The analyzer of example 34, wherein the at least one value derived from the image of the particle from the biological sample comprises: a focus quality of the image of the particle in the biological sample; a staining quality of the image of the particle in the biological sample; a front facing orientation of the particle; and/or a measurement of the particle.

### Example 36

The analyzer of any of examples 31-35, wherein the one or more metadata values comprise at least one value which corresponds to the biological sample.

### Example 37

The analyzer of example 36, wherein the one or more metadata values comprise: a total number of particles depicted in images taken during analysis of the biological sample; and/or a time elapse following the biological sample being acquired from a patient.

### Example 38

The analyzer of any of examples 31-37, wherein classifying the particle from the biological sample based on the image and on the one or more metadata values comprises selecting a classification algorithm for classifying the particle based on at least one of the one or more metadata values.

### Example 39

The analyzer of any of examples 31-38, wherein classifying the particle from the biological sample based on the image and on the one or more metadata values comprises providing both the image and at least one of the one or more metadata values to a classification model as input.

### Example 40

The analyzer of example 39, wherein: the classification model is a convolutional neural network comprising one or more convolutional layers and one or more fully connected layers; and providing both the image and at least one of the one or more metadata values to the classification model as input comprises: providing the image of the particle from the biological sample to a convolutional layer as input; and providing at least one of the one or more metadata values to a fully connected layer as input.

### Example 41

The analyzer of any of examples 31-40, wherein: the set of acts comprises generating a preliminary classification for the particle from the biological sample based on the image; and classifying the particle from the biological sample based on the image and on the one or more metadata values comprises generating a final classification for the particle from the biological sample based on at least one of the one or more metadata values.

### Example 42

The analyzer of any of examples 31-41, wherein obtaining the image of the particle from the biological sample comprises flowing the biological sample through the flowcell and imaging the particle when it is in the flowcell using the camera.

### Example 43

A non-transitory computer readable medium storing instructions for performing the set of acts of the instructions stored on the non-transitory computer readable medium of any of examples 31-42.

### Example 44

A method comprising performing the set of acts of the instructions stored on the non-transitory computer readable medium of any of examples 31-42.

### Example 45

A system comprising: one or more processors; and a non-transitory computer readable medium having stored thereon instructions for performing the set of acts of the instructions stored on the non-transitory computer readable medium of any of examples 31-41 when executed using the one or more processors.

### Example 46

A method comprising: obtaining an image of a particle from a biological sample; obtaining one or more metadata values corresponding to the particle from the biological sample; and using the image of the particle and the one or more metadata values corresponding to the particle to train a classifier to classify particles in biological samples.

The method of example 46, wherein: the classifier comprises a plurality of classification algorithms, each of which is selectable based on at least one of the one or more metadata values; training the classifier to classify particles in biological samples using the image of the particle and the one or more metadata values corresponding to the particle comprises: selecting a classification algorithm from the plurality of classification algorithms based on the one or more metadata values corresponding to the particle; and training the selected classification algorithm to classify particles using the image of the particle from the biological sample.

### Example 48

The method of example 47, wherein the plurality of classification algorithms comprises: a positive focus algorithm, wherein the positive focus algorithm is trained to classify particles in images which are positively out of focus; a in focus algorithm, wherein the in focus algorithm is trained to classify particles in images which are in focus; a negative focus algorithm, wherein the negative focus algorithm is trained to classify particles in images which are negatively out of focus; and wherein the positive focus algorithm, the negative focus algorithm, and the in focus algorithm are each selectable based on focus metadata values.

### Example 49

The method of any of examples 47-48, wherein the plurality of classification algorithms comprise: a heavily stained algorithm, wherein the heavily stained algorithm is trained to classify particles in images which correspond to metadata values for a heavily stained category; and a lightly stained algorithm, wherein the lightly stained algorithm is trained to classify particles in images which correspond to metadata values for a lightly stained category.

### Example 50

The method of example 46, wherein training the classifier to classify particles in biological samples using the image of the particle and the one or more metadata values corresponding to the particle comprises: providing both the image and at least one of the one or more metadata values to a classification model as input; performing a comparison comparing a classification provided by the classification model with a ground truth classification for the particle; and updating the classification model based on the comparison.

### Example 51

The method of example 50, wherein: the classification model is a convolutional neural network comprising one or more convolutional layers and one or more fully connected layers; and providing both the image and at least one of the one or more metadata values to the classification model as input comprises: providing the image of the particle from the biological sample to a convolutional layer as input; and providing at least one of the one or more metadata values to a fully connected layer as input.

### Example 52

The method of any of examples 46-51, wherein: the image of the particle from the biological sample is a patch image having a location in a field of view; and the one or more metadata values comprise: the location of the patch image in the field of view; and/or values of pixels in a blank image patch located at the location of the image of the particle from the biological sample in the field of view.

### Example 53

The method of any of examples 46-52, wherein: the image of the particle from the biological sample has an index in a sequence of images of the biological sample; and the one or more metadata values comprise the index of the image of the particle in the biological sample in the sequence of images of the biological sample.

### Example 54

The method of any of examples 46-53, wherein the one or more metadata values comprise at least one value derived from the image of the particle from the biological sample.

The method of example 54, wherein the at least one value derived from the image of the particle from the biological sample comprises: a focus quality of the image of the particle in the biological sample; a staining quality of the image of the particle in the biological sample; a front facing orientation of the particle; and/or a measurement of the particle.

### Example 56

The method of any of examples 46-55, wherein the one or more metadata values comprise at least one value which corresponds to the biological sample.

### Example 57

The method of example 56, wherein the one or more metadata values comprise: a total number of particles depicted in images taken of the biological sample; and/or a time elapse following the biological sample being acquired from a patient.

### Example 58

The method of any of examples 46-57, wherein obtaining the image of the particle from the biological sample comprises flowing the biological sample through a flowcell and imaging the particle when it is in the flowcell using a camera.

### Example 59

A non-transitory computer readable medium storing instructions for performing the method of any of examples 46-58.

### Example 60

A system comprising: one or more processors; and a non-transitory computer readable medium having stored thereon instructions for performing the method of any of examples 46-58 when executed using the one or more processors.

A system comprising: one or more processors; and a non-transitory computer readable medium having stored thereon instructions for performing a set of acts when executed using the one or more processors, the set of acts comprising: obtaining an image of a particle from a biological sample; obtaining one or more metadata values corresponding to the particle from the biological sample; and using the image of the particle and the one or more metadata values corresponding to the particle to train a classifier to classify particles in biological samples.

### Example 62

The system of example 61, wherein: the classifier comprises a plurality of classification algorithms, each of which is selectable based on at least one of the one or more metadata values; training the classifier to classify particles in biological samples using the image of the particle and the one or more metadata values corresponding to the particle comprises: selecting a classification algorithm from the plurality of classification algorithms based on the one or more metadata values corresponding to the particle; and training the selected classification algorithm to classify particles using the image of the particle from the biological sample.

### Example 63

The system of example 62, wherein the plurality of classification algorithms comprises: a positive focus algorithm, wherein the positive focus algorithm is trained to classify particles in images which are positively out of focus; a in focus algorithm, wherein the in focus algorithm is trained to classify particles in images which are in focus; a negative focus algorithm, wherein the negative focus algorithm is trained to classify particles in images which are negatively out of focus; and wherein the positive focus algorithm, the negative focus algorithm, and the in focus algorithm are each selectable based on focus metadata values.

### Example 64

The system of any of examples 62-63, wherein the plurality of classification algorithms comprise: a heavily stained algorithm, wherein the heavily stained algorithm is trained to classify particles in images which correspond to metadata values for a heavily stained category; and a lightly stained algorithm, wherein the lightly stained algorithm is trained to classify particles in images which correspond to metadata values for a lightly stained category.

### Example 65

The system of example 61, wherein training the classifier to classify particles in biological samples using the image of the particle and the one or more metadata values corresponding to the particle comprises: providing both the image and at least one of the one or more metadata values to a classification model as input; performing a comparison comparing a classification provided by the classification model with a ground truth classification for the particle; and updating the classification model based on the comparison.

### Example 66

The system of example 65, wherein: the classification model is a convolutional neural network comprising one or more convolutional layers and one or more fully connected layers; and providing both the image and at least one of the one or more metadata values to the classification model as input comprises: providing the image of the particle from the biological sample to a convolutional layer as input; and providing at least one of the one or more metadata values to a fully connected layer as input.

### Example 67

The system of any of examples 61-66, wherein: the image of the particle from the biological sample is a patch image having a location in afield of view; and the one or more metadata values comprise: the location of the patch image in the field of view; and/or values of pixels in a blank image patch located at the location of the image of the particle from the biological sample in the field of view.

### Example 68

The system of any of examples 61-67, wherein: the image of the particle from the biological sample has an index in a sequence of images of the biological sample; and the one or more metadata values comprise the index of the image of the particle in the biological sample in the sequence of images of the biological sample.

### Example 69

The system of any of examples 61-68, wherein the one or more metadata values comprise at least one value derived from the image of the particle from the biological sample.

### Example 70

The system of example 69, wherein the at least one value derived from the image of the particle from the biological sample comprises: a focus quality of the image of the particle in the biological sample; a staining quality of the image of the particle in the biological sample; a front facing orientation of the particle; and/or a measurement of the particle.

### Example 71

The system of any of examples 61-70, wherein the one or more metadata values comprise at least one value which corresponds to the biological sample.

### Example 72

The system of example 71, wherein the one or more metadata values comprise: a total number of particles depicted in images taken of the biological sample, and/or a time elapse following the biological sample being acquired from a patient.

### Example 73

The system of any of examples 61-72, wherein obtaining the image of the particle from the biological sample comprises flowing the biological sample through a flowcell and imaging the particle when it is in the flowcell using a camera.

### Example 74

A non-transitory computer readable medium storing instructions for performing the set of acts of the instructions stored on the non-transitory computer readable medium of any of claims 61-73.

A method comprising performing the set of acts of the instructions stored on the non-transitory computer readable medium of any of claims 61-73.

### Example 76

An analyzer comprising: one or more processors; a camera; a flowcell, and a non-transitory computer readable medium having stored thereon instructions for performing a set of acts when executed using the one or more processors, the set of acts comprising: obtaining an image of a particle from a biological sample; obtaining one or more metadata values corresponding to the particle from the biological sample; and using the image of the particle and the one or more metadata values corresponding to the particle to rain a classifier to classify particles in biological samples.

### Example 77

The analyzer of example 76, wherein: the classifier comprises a plurality of classification algorithms, each of which is selectable based on at least one of the one or more metadata values; training the classifier to classify particles in biological samples using the image of the particle and the one or more metadata values corresponding to the particle comprises: selecting a classification algorithm from the plurality of classification algorithms based on the one or more metadata values corresponding to the particle; and training the selected classification algorithm to classify particles using the image of the particle from the biological sample.

### Example 78

The analyzer of example 77, wherein the plurality of classification algorithms comprises: a positive focus algorithm, wherein the positive focus algorithm is trained to classify particles in images which are positively out of focus; a in focus algorithm, wherein the in focus algorithm is trained to classify particles in images which are in focus; a negative focus algorithm, wherein the negative focus algorithm is trained to classify particles in images which are negatively out of focus; and wherein the positive focus algorithm, the negative focus algorithm, and the in focus algorithm are each selectable based on focus metadata values.

### Example 79

The analyzer of any of examples 77-78, wherein the plurality of classification algorithms comprise: a heavily stained algorithm, wherein the heavily stained algorithm is trained to classify particles in images which correspond to metadata values for a heavily stained category; and a lightly stained algorithm, wherein the lightly stained algorithm is trained to classify particles in images which correspond to metadata values for a lightly stained category.

### Example 80

The analyzer of example 76, wherein training the classifier to classify particles in biological samples using the image of the particle and the one or more metadata values corresponding to the particle comprises: providing both the image and at least one of the one or more metadata values to a classification model as input; performing a comparison comparing a classification provided by the classification model with a ground truth classification for the particle; and updating the classification model based on the comparison.

### Example 81

The analyzer of example 80, wherein: the classification model is a convolutional neural network comprising one or more convolutional layers and one or more fully connected layers; and providing both the image and at least one of the one or more metadata values to the classification model as input comprises: providing the image of the particle from the biological sample to a convolutional layer as input; and providing at least one of the one or more metadata values to a fully connected layer as input.

### Example 82

The analyzer of any of examples 76-81, wherein: the image of the particle from the biological sample is a patch image having a location in a field of view; and the one or more metadata values comprise: the location of the patch image in the field of view; and/or values of pixels in a blank image patch located at the location of the image of the particle from the biological sample in the field of view.

The analyzer of any of examples 76-82, wherein: the image of the particle from the biological sample has an index in a sequence of images of the biological sample; and the one or more metadata values comprise the index of the image of the particle in the biological sample in the sequence of images of the biological sample.

### Example 84

The analyzer of any of examples 76-83, wherein the one or more metadata values comprise at least one value derived from the image of the particle from the biological sample.

### Example 85

The analyzer of example 84, wherein the at least one value derived from the image of the particle from the biological sample comprises: a focus quality of the image of the particle in the biological sample; a staining quality of the image of the particle in the biological sample; a front facing orientation of the particle; and/or a measurement of the particle.

### Example 86

The analyzer of any of examples 76-85, wherein the one or more metadata values comprise at least one value which corresponds to the biological sample.

### Example 87

The analyzer of example 86, wherein the one or more metadata values comprise: a total number of particles depicted in images taken of the biological sample; and/or a time elapse following the biological sample being acquired from a patient.

### Example 88

The analyzer of any of examples 76-87, wherein obtaining the image of the particle from the biological sample comprises flowing the biological sample through the flowcell and imaging the particle when it is in the flowcell using the camera.

A non-transitory computer readable medium storing instructions for performing the set of acts of the instructions stored on the non-transitory computer readable medium of any of claims 76-88.

### Example 90

A method comprising performing the set of acts of the instructions stored on the non-transitory computer readable medium of any of examples 76-88.

Each of the calculations or operations described herein may be performed using a computer or other processor having hardware, software, and/or firmware. The various method steps may be performed by modules, and the modules may comprise any of a wide variety of digital and/or analog data processing hardware and/or software arranged to perform the method steps described herein. The modules optionally comprising data processing hardware adapted to perform one or more of these steps by having appropriate machine programming code associated therewith, the modules for two or more steps (or portions of two or more steps) being integrated into a single processor board or separated into different processor boards in any of a wide variety of integrated and/or distributed processing architectures. These methods and systems will often employ a tangible media embodying machine-readable code with instructions for performing the method steps described above. Suitable tangible media may comprise a memory (including a volatile memory and/or a non-volatile memory), a storage media (such as a magnetic recording on a floppy disk, a hard disk, a tape, or the like; on an optical memory such as a CD, a CD-R/W, a CD-ROM, a DVD, or the like; or any other digital or analog storage media), or the like.

All patents, patent publications, patent applications, journal articles, books, technical references, and the like discussed in the instant disclosure are incorporated herein by reference in their entirety for all purposes.

Different arrangements of the components depicted in the drawings or described above, as well as components and steps not shown or described are possible. For example, in some cases, aspects of processing described herein (e.g., training of machine learning algorithms, application of machine learning algorithms to images taken of patient samples) may be performed in various configurations—for instance, using a processor which his comprised by (or local to) an analyzer, a parallel-processing arrangement, or processing being performed remotely from the analyzer which captures images (such as using a cloud based platform, or using a remotely linked computer or system to process the analyzer data). Similarly, some features and sub-combinations are useful and may be employed without reference to other features and sub-combinations. Embodiments of the invention have been described for illustrative and not restrictive purposes, and alternative embodiments will become apparent to readers of this patent. In certain cases, method steps or operations may be performed or executed in differing order, or operations may be added, deleted or modified. It can be appreciated that, in certain aspects of the invention, a single component may be replaced by multiple components, and multiple components may be replaced by a single component, to provide an element or structure or to perform a given function or functions. Except where such substitution would not be operative to practice certain embodiments of the invention, such substitution is considered within the scope of the invention. Accordingly, the claims should not be treated as limited to the examples, drawings, embodiments and illustrations provided above, but instead should be understood as having the scope provided when their terms are given their broadest reasonable interpretation as provided by a general purpose dictionary, except that when a term or phrase is indicated as having a particular meaning under the heading Explicit Definitions, it should be understood as having that meaning when used in the claims.

### Explicit Definitions

It should be understood that, in the above examples and the claims, a statement that something is “based on” something else should be understood to mean that it is determined at least in part by the thing that it is indicated as being based on. To indicate that something must be completely determined based on something else, it is described as being “based EXCLUSIVELY on” whatever it must be completely determined by.

It should be understood that, in the above examples and claims, the term “set” should be understood as one or more things which are grouped together.

1. A method of biological analysis comprising:
obtaining an image of a particle from a biological sample;
obtaining one or more metadata values corresponding to the particle from the biological sample; and
classifying the particle from the biological sample based on the image and on the one or more metadata values.

2. The method of claim 1, wherein:
the image of the particle from the biological sample is a patch image having a location in a field of view; and
the one or more metadata values comprise at least one of: the location of the patch image in the field of view, and values of pixels in a blank image patch located at the location of the image of the particle from the biological sample in the field of view.

3. The method of claim 2, wherein:
the image of the particle from the biological sample has an index in a sequence of images of the biological sample; and
the one or more metadata values comprise the index of the image of the particle in the biological sample in the sequence of images of the biological sample.

4. The method of claim 1, wherein the one or more metadata values comprise at least one value derived from the image of the particle from the biological sample, the particle comprises a white blood cell, and the at least one value derived from the image of the particle comprises at least one of:
a focus quality of the image of the particle in the biological sample; and
a staining quality of the image of the particle in the biological sample.

5. The method of claim 1, wherein the one or more metadata values comprise at least one value which corresponds to the biological sample, and the at least one value which corresponds to the biological sample comprises at least one of:
a total number of particles depicted in images taken during analysis of the biological sample; and
a time elapse following the biological sample being acquired from a patient.

6. The method of claim 1, wherein classifying the particle from the biological sample based on the image and on the one or more metadata values comprises selecting a classification algorithm for classifying the particle based on at least one of the one or more metadata values.

7. The method of claim 1, wherein classifying the particle from the biological sample based on the image and on the one or more metadata values comprises providing both the image and at least one of the one or more metadata values to a classification model as input.

8. The method of claim 7, wherein:
the classification model is a convolutional neural network comprising one or more convolutional layers and one or more fully connected layers; and
providing both the image and at least one of the one or more metadata values to the classification model as input comprises:
providing the image of the particle from the biological sample to a convolutional layer as input; and
providing at least one of the one or more metadata values to a fully connected layer as input.

9. The method of claim 1, wherein:
the method comprises generating a preliminary classification for the particle from the biological sample based on the image; and
classifying the particle from the biological sample based on the image and on the one or more metadata values comprises generating a final classification for the particle from the biological sample based on at least one of the one or more metadata values.

10. The method of claim 1, wherein obtaining the image of the particle from the biological sample comprises flowing the biological sample through a flowcell and imaging the particle when it is in the flowcell using a camera.

11. The method of claim 1, wherein the one or more metadata values comprise at least one value derived from the image of the particle from the biological sample, the particle comprises a red blood cell, and the at least one value derived from the image of the particle comprises front facing alignment of the image of the particle in the biological sample.

12. A system for biological analysis comprising:
one or more processors;
a camera;
a flowcell; and
a non-transitory computer readable medium having stored thereon instructions for performing a set of acts when executed using the one or more processors, the set of acts comprising:
obtaining an image of a particle from a biological sample;
obtaining one or more metadata values corresponding to the particle from the biological sample; and
classifying the particle from the biological sample based on the image and on the one or more metadata values.

13. The system of claim 12, wherein:
the image of the particle from the biological sample is a patch image having a location in a field of view; and
the one or more metadata values comprise:
the location of the patch image in the field of view; and/or
values of pixels in a blank image patch located at the location of the image of the particle from the biological sample in the field of view.

14. The system of claim 13, wherein:
the image of the particle from the biological sample has an index in a sequence of images of the biological sample; and
the one or more metadata values comprise the index of the image of the particle in the biological sample in the sequence of images of the biological sample.

15. The system of claim 12, wherein the one or more metadata values comprise at least one value derived from the image of the particle from the biological sample, the particle comprises a white blood cell, and the at least one value derived from the image of the particle from the biological sample comprises at least one of:
a focus quality of the image of the particle in the biological sample; and
a staining quality of the image of the particle in the biological sample.

16. The system of claim 12, wherein the one or more metadata values comprise at least one value which corresponds to the biological sample, and wherein the at least one value which corresponds to the biological sample comprises at least one of:
a total number of particles depicted in images taken during analysis of the biological sample; and
a time elapse following the biological sample being acquired from a patient.

17. The system of claim 12, wherein classifying the particle from the biological sample based on the image and on the one or more metadata values comprises selecting a classification algorithm for classifying the particle based on at least one of the one or more metadata values.

18. The system of claim 12, wherein classifying the particle from the biological sample based on the image and on the one or more metadata values comprises providing both the image and at least one of the one or more metadata values to a classification model as input.

19. The system of claim 18, wherein:
the classification model is a convolutional neural network comprising one or more convolutional layers and one or more fully connected layers; and
providing both the image and at least one of the one or more metadata values to the classification model as input comprises:
providing the image of the particle from the biological sample to a convolutional layer as input; and
providing at least one of the one or more metadata values to a fully connected layer as input.

20. The system of claim 12, wherein:
the set of acts comprises generating a preliminary classification for the particle from the biological sample based on the image; and
classifying the particle from the biological sample based on the image and on the one or more metadata values comprises generating a final classification for the particle from the biological sample based on at least one of the one or more metadata values.

21. The system of claim 12, wherein obtaining the image of the particle from the biological sample comprises flowing the biological sample through a flowcell and imaging the particle when it is in the flowcell using a camera.

22. The system of claim 12, wherein the one or more metadata values comprise at least one value derived from the image of the particle from the biological sample, the particle comprises a red blood cell, and the at least one value derived from the image of the particle comprises front facing alignment of the image of the particle in the biological sample.
